(19) United States
(12) Patent Application Publication
(10) Pub. No.: US 2021/0406869 A1
(43) Pub. Date: Dec. 30, 2021

(54) METHODS, SYSTEMS AND COMPUTER PROGRAM PRODUCTS FOR MODIFYING CONTACTLESS PAYMENT CARD CONFIGURATIONS

(71) Applicant: Mastercard International Incorporated, Purchase, NY (US)

(72) Inventors: Dipali Pathrabe, Pune (IN); Naveen Kumar Gupta, Pune (IN); Ajay Sinha, Pune (IN)

(73) Assignee: Mastercard International Incorporated, Purchase, NY (US)

(21) Appl. No.: 17/313,596

(22) Filed: May 6, 2021

(30) Foreign Application Priority Data
Jun. 25, 2020 (IN) 202011027077

(51) Int. Cl. G06Q 20/34; G06Q 20/02; G06Q 20/32; G06Q 20/40; G06Q 20/38; H04L 9/08

(52) U.S. Cl. CPC G06Q 20/3563; G06Q 20/352; G06Q 20/02; G06Q 20/204; G06Q 20/40975; G06Q 20/3829; H04L 9/0866; G06Q 20/322

(57) ABSTRACT

The invention provides methods, systems and computer program products for modifying priority parameters corresponding to a software payment application within a contactless payment card. In an embodiment the invention comprises (i) establishing communication between the contactless payment card and a mobile communication device, (ii) parsing an application directory listing stored within the payment card, (iii) extracting information corresponding to a plurality of software payment applications stored within the payment card, (iv) selecting a software payment application from among the plurality of software payment applications, (v) specifying a modification to a priority tag value associated with the selected software payment application, (vi) receiving an encrypted unique identifier associated with the payment card from an issuer server, and modifying the priority tag associated with the selected software payment application, provided the received encrypted unique identifier matches payment card identifier information stored within the memory of the contactless payment card.

### CROSS REFERENCE TO RELATED APPLICATIONS

This application claims priority to Indian Application No. 202011027077, filed Jun. 25, 2020, which is incorporated herein by reference in its entirety.

### FIELD OF THE INVENTION

The present invention relates to the domain of payment card transactions, and more particularly to methods, systems and computer program products for managing and selectively modifying the configuration of a chip based payment card that has a plurality of payment card applications implemented therewithin.

### BACKGROUND OF THE INVENTION

With growing acceptance of payment cards (e.g. credit cards and debit cards) as instruments for effecting electronic payment transactions, there have been corresponding advances in technologies for enabling payment cards to interface with point-of-sale (POS) terminals during transaction execution.

FIG. 1 illustrates a conventional system environment 100 for implementing a POS terminal-based payment transaction—within which the present invention may be implemented. In system environment 100, payment card 102 interfaces with POS terminal 104, and a payment transaction is initiated based on payment card information retrieved by POS terminal 104 from payment card 102 over a communication interface provided within payment card 102.

The payment card information retrieved by POS terminal 104 from payment card 102 may include at least a payment card number. POS terminal 104 transmits the payment card number, a payee account identifier, and a payment amount through network 106 to an acquirer network 108 (i.e. a data network maintained by an acquirer institution with which the payee account is maintained). Acquirer network 108 in turn transmits the payment instruction to issuer network 110 (i.e. a data network maintained by an issuer institution which has issued payment card 102 to the corresponding payor) through payment network 112 (i.e. a data network maintained by an intermediary between the payee's acquirer and the payor's issuer—for example, Mastercard® or Visa®). Subject to successful authorization of the payment card, the requested payment is authorized and the payment amount is transferred from a payment account associated with payment card 102 to the payee account. Confirmation of successful transaction completion may thereafter be transmitted back to POS terminal 104.

Initially, the default interface capability for payment cards consisted of a magnetic stripe that stored payment card information, and which require to be swiped through a magnetic card reader integrated into or coupled with a POS terminal, to enable the POS terminal to read payment card information. Subsequently, payment cards have additionally incorporated a microprocessor chip or smartchip that is configured to interact with a POS terminal when the contacts of the smartchip are physically interfaced with a smartchip reader that is integrated into or coupled with a POS terminal. The microprocessor chip or smartchip enables the POS terminal to read payment card information stored within the smartchip or on a memory within the payment card. Recently, payment cards also incorporate a radio frequency antenna or a contactless communication chip, which, respond to detection of electromagnetic waves of an appropriate radio frequency (for example, electromagnetic waves generated by a POS terminal) by contactlessly transmitting payment card information to the POS terminal.

The incorporation of microprocessor chips within a payment card has led to the further development of payment cards that are capable of selectively performing a plurality of different functions—e.g. selectively functioning as a credit card, or debit card or cash card. Payment cards can implement multi-functionality by having a plurality of different software payment applications stored within a memory of the payment card, wherein depending on a desired functionality, one of the plurality of software payment applications is retrieved and executed by the payment card chip or microprocessor. In the case of wireless or contactless payment transactions, to ensure that a payment card microprocessor is capable of correctly selecting a software payment application for retrieval and execution, each of the plurality of software payment applications is assigned a priority through a corresponding priority information tag or flag stored within the payment card memory. The respective priorities of the software payment applications determines which specific software payment application is selected for execution of a payment transaction. Typically, the software payment application having the highest priority or having an active priority is used to implement a contactless payment transaction (when a contactless payment trigger event, such as a card tap event, is initiated using the payment card). The remaining software payment applications having lower priorities or an inactive priority would not be used for a contactless transaction. So for example, if a credit card software payment application within a payment card has been assigned a priority of 1, while a debit card software payment application within the same payment card has been assigned a priority of 0, tapping the payment card on a contactless payment card reader will result in implementation of a credit card transaction and not a debit card transaction.

The arrangement of having different priorities assigned to software payment applications within a payment card has created the need to be able to modify such priorities, so as to enable a user to modify the order of selection of payment functionality when a contactless payment card is used for a payment transaction. Additionally, any such modification requires to be convenient and capable of being implemented by a cardholder without having to surrender or submit the payment card to a card issuer for carrying out the modification. At the same time, any such modifications require to be implemented in a secure manner that does not compromise security of the payment card or of the card issuer or of a payment network associated with the payment card.

### BRIEF DESCRIPTION OF THE ACCOMPANYING DRAWINGS

FIG. 1 illustrates a system environment for implementing a POS terminal-based payment transaction.

FIGS. 2 and 3 illustrate front and rear views of an exemplary contactless payment card.

FIG. 4 illustrates an exemplary POS terminal configured to interface with a payment card through a plurality of payment card interfaces.

FIG. 5 illustrates internal components within the exemplary contactless payment card of FIGS. 2 and 3.

FIG. 6 illustrates a memory element within a contactless payment card, having a plurality of software payment applications stored therewithin.

FIGS. 7 and 8 illustrate system environments for enabling configuration of priority parameters corresponding to one or more software payment applications within a contactless payment card.

FIG. 9 is a flowchart illustrating a method of configuring priority parameters corresponding to one or more software payment applications within a contactless payment card.

FIG. 10 is a flowchart illustrating method steps implemented within a mobile communication device for configuring priority parameters corresponding to one or more software payment applications within a contactless payment card.

FIG. 11 is a flowchart illustrating method steps implemented within a payment card processor for configuring priority parameters corresponding to one or more software payment applications within a contactless payment card.

FIG. 12 is a communication flow diagram illustrating communication flow between system entities involved in configuring priority parameters corresponding to one or more software payment applications within a contactless payment card.

FIG. 13 illustrates internal components within an exemplary mobile communication device which may be configured to implement the method steps of FIG. 9 and/or 10.

FIG. 14 illustrates internal components within an exemplary payment card which may be configured to implement the method steps of FIGS. 9 and/or 11.

FIG. 15 illustrates an exemplary computer system according to which various embodiments of the present invention may be implemented.

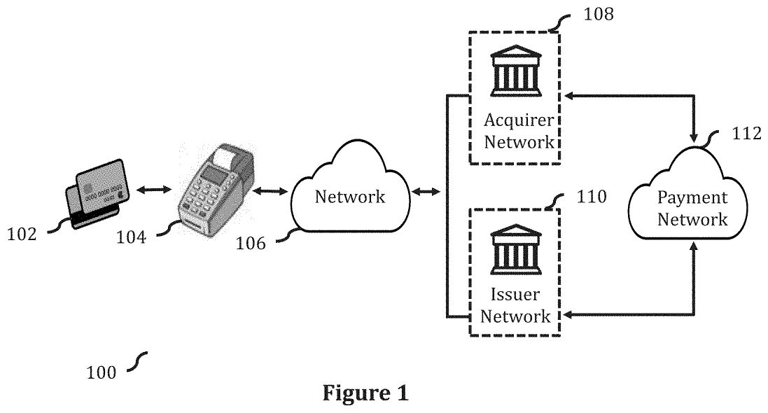

### SUMMARY

The present invention relates to the domain of payment card transactions, and more particularly to methods, systems and computer program products for managing and selectively modifying the configuration of a chip based payment card that has a plurality of software payment applications implemented therewithin.

In a method embodiment, the invention provides method for modifying priority parameters corresponding to a software payment application within a contactless payment card. The method comprises (i) establishing communication between the contactless payment card and a mobile communication device, (ii) initiating parsing of an application directory listing stored within a memory of the contactless payment card, (iii) extracting information corresponding to a plurality of software payment applications stored within the memory of the contactless payment card, (iv) receiving user input selecting a software payment application from among the plurality of software payment applications, (v) receiving user input specifying a modification to a value of a priority tag associated with the selected software payment application, (vi) receiving from an issuer server, an encrypted unique identifier associated with the contactless payment card, and initiating modification of the priority tag associated with the selected software payment application, wherein (a) said modification comprises implementing the modification to the value of the priority tag, as specified by the received user input, and (b) said modification is implemented responsive to a processor within the contactless payment card determining that the encrypted unique identifier received from the issuer server matches payment card identifier information stored within the memory of the contactless payment card.

In a specific embodiment of the method, parsing of the application directory listing is implemented by the processor within the contactless payment card.

In another embodiment of the method, the extracted information corresponding to each of the plurality of software applications comprises an application identifier and a priority tag value. The extracted information corresponding to each of the plurality of software applications may be displayed on a display of the mobile communication device. In a particular embodiment of the method, the user input selecting a software payment application from among the plurality of software payment applications, comprises a selection of an application identifiers corresponding to one of the plurality of software applications.

According to a method embodiment, one or more of the application directory listing, the extracted information corresponding to the plurality of software payment applications, the plurality of software payment applications and the payment card identifier information are stored within a proximity payment system environment implemented within a memory of the contactless payment card.

In another method embodiment, (i) the modification to the value of the priority tag, as specified by the received user input is implemented by the processor within the contactless payment card, or (ii) the determination that the encrypted unique identifier received from the issuer server matches payment card identifier information stored within the memory of the contactless payment card, is implemented by the processor within the contactless payment card.

In an implementation of the method, the determination that the encrypted unique identifier received from the issuer server matches payment card identifier information stored within the memory of the contactless payment card, may be based on (i) encrypting the payment card identifier information stored within the memory of the contactless payment card and comparing said encrypted payment card identifier information against the encrypted unique identifier received from the issuer server, or (ii) decrypting the encrypted unique identifier received from the issuer server, and comparing the decrypted unique identifier against the payment card identifier information stored within the memory of the contactless payment card.

In a specific embodiment of the method, encryption of the payment card identifier information stored within the memory of the contactless payment card, or decryption of the encrypted unique identifier received from the issuer server is based on a cryptographic key retrieved from the memory of the contactless payment card.

In a more particular embodiment of the method, (i) the cryptographic key retrieved from the memory of the contactless payment card comprises a symmetric cryptographic key has been used by the issuer server to generate the encrypted unique identifier, or (ii) the cryptographic key retrieved from the memory of the contactless payment card comprises one of a private key-public key pair, and the other of said private key-public key pair has been used by the issuer server to generate the encrypted unique identifier.

In another embodiment, the invention provides A mobile communication device configured for enabling modification of priority parameters corresponding to a software payment application within a contactless payment card. The mobile communication device comprises (i) a memory, (ii) a network transceiver, (iii) a contactless transceiver configured to enable communication with contactless payment cards based on one or more wireless communication protocols, and (iv) at least one processor configured for (a) establishing communication between the contactless payment card and a mobile communication device, (b) initiating parsing of an application directory listing stored within a memory of the contactless payment card, (c) extracting information corresponding to a plurality of software payment applications stored within the memory of the contactless payment card, (d) receiving user input selecting a software payment application from among the plurality of software payment applications, (e) receiving user input specifying a modification to a value of a priority tag associated with the selected software payment application, (f) receiving from an issuer server, an encrypted unique identifier associated with the contactless payment card, and (g) initiating modification of the priority tag associated with the selected software payment application, wherein (1) said modification comprises implementing the modification to the value of the priority tag, as specified by the received user input, and (2) said modification is implemented responsive to a processor within the contactless payment card determining that the encrypted unique identifier received from the issuer server matches payment card identifier information stored within the memory of the contactless payment card.

In an embodiment, the mobile communication device may be configured such that parsing of the application directory listing is implemented by the processor within the contactless payment card.

In another embodiment, the mobile communication device may be configured such that the extracted information corresponding to each of the plurality of software applications comprises an application identifier and a priority tag value.

In a further embodiment, the mobile communication device may be configured such that the extracted information corresponding to each of the plurality of software applications is displayed on a display of the mobile communication device.

In yet another embodiment, the mobile communication device is configured such that the user input selecting a software payment application from among the plurality of software payment applications, comprises a selection of an application identifiers corresponding to one of the plurality of software applications.

The mobile communication device may be configured such that one or more of the application directory listing, the extracted information corresponding to the plurality of software payment applications, the plurality of software payment applications and the payment card identifier information are stored within a proximity payment system environment implemented within a memory of the contactless payment card.

In an alternate embodiment, the mobile communication device may be configured such that (i) the modification to the value of the priority tag, as specified by the received user input is implemented by the processor within the contactless payment card, or (ii) the determination that the encrypted unique identifier received from the issuer server matches payment card identifier information stored within the memory of the contactless payment card, is implemented by the processor within the contactless payment card.

In a specific embodiment, the mobile communication device may be configured such that the determination that the encrypted unique identifier received from the issuer server matches payment card identifier information stored within the memory of the contactless payment card, is based on (i) encrypting the payment card identifier information stored within the memory of the contactless payment card and comparing said encrypted payment card identifier information against the encrypted unique identifier received from the issuer server, or (ii) decrypting the encrypted unique identifier received from the issuer server, and comparing the decrypted unique identifier against the payment card identifier information stored within the memory of the contactless payment card.

In one embodiment, the mobile communication device may be configured such that encryption of the payment card identifier information stored within the memory of the contactless payment card, or decryption of the encrypted unique identifier received from the issuer server is based on a cryptographic key retrieved from the memory of the contactless payment card.

In another embodiment, the mobile communication device may be configured such that (i) the cryptographic key retrieved from the memory of the contactless payment card comprises a symmetric cryptographic key has been used by the issuer server to generate the encrypted unique identifier, or (ii) the cryptographic key retrieved from the memory of the contactless payment card comprises one of a private key-public key pair, and the other of said private key-public key pair has been used by the issuer server to generate the encrypted unique identifier.

The invention also provides a computer program product for modifying priority parameters corresponding to a software payment application within a contactless payment card, comprising a non-transitory computer usable medium having a computer readable program code embodied therein, the computer readable program code comprising instructions for (i) establishing communication between the contactless payment card and a mobile communication device, (ii) initiating parsing of an application directory listing stored within a memory of the contactless payment card, (ii) extracting information corresponding to a plurality of software payment applications stored within the memory of the contactless payment card, (iii) receiving user input selecting a software payment application from among the plurality of software payment applications, (iv) receiving user input specifying a modification to a value of a priority tag associated with the selected software payment application, (v) receiving from an issuer server, an encrypted unique identifier associated with the contactless payment card, and (vi) initiating modification of the priority tag associated with the selected software payment application, wherein (a) said modification comprises implementing the modification to the value of the priority tag, as specified by the received user input, and (b) said modification is implemented responsive to a processor within the contactless payment card determining that the encrypted unique identifier received from the issuer server matches payment card identifier information stored within the memory of the contactless payment card.

### DETAILED DESCRIPTION

For the purposes of the present invention, the following terms shall be understood to have the corresponding meanings provided below.

“Acquirer” shall mean a business (e.g., a financial institution or a merchant bank) that contracts with a merchant or payee to coordinate with an issuer of a payor's payment card or payment account.

“Acquirer network” shall refer to one or more servers, including hardware, software and other equipment used by an acquirer to transmit and process payment card based transactions or payment account based transactions and information related to merchants, customers, payment cards, payment accounts and/or transactions.

“Application Identifier” or “AID” shall mean a unique application identifier associated with specific software payment application stored within a payment card.

“Issuer” shall mean a financial institution that issues payment cards or payment accounts to users.

“Issuer network” shall refer to one or more servers, including hardware, software and other equipment used by an issuer to transmit and process payment card transactions or payment account transactions and information related to customers, payment cards, payment accounts and/or transactions.

“Payee” and “Merchant” may be used interchangeably to designate an individual or entity receiving an electronic payment.

“Payment account” shall mean any account that may be used for the purposes of effecting an electronic payment or electronic transaction, and shall include any electronic transaction account, payment card account, bank account or electronic wallet account.

“Payment card” shall mean a card or data associated with a payment account that may be provided to a merchant or payee in order to enable a financial transaction via the associated payment account. Payment cards may include credit cards, debit cards, charge cards, stored-value cards, prepaid cards, fleet cards, virtual payment numbers, virtual card numbers, controlled payment numbers, etc.

“Payment network” shall refer to any intermediary network communicatively disposed between any two or more of the merchant server, acquirer bank server and issuer bank server. In certain embodiments, the payment network may comprise a card network that enables communication between the issuer bank and the acquirer bank (for example, Mastercard® or Visa®). In such embodiments, the card network primarily coordinates payment card transactions between acquirers and issuers, and additionally coordinates clearing and settlement services to transfer payments from issuers to merchants.

“Payor”, “consumer” and “customer” may be used interchangeably to designate an individual or entity making an electronic payment.

“Priority tag” shall mean a data field associated with a software payment application within a payment card, comprising one or more data values that represent a priority assigned to the software payment application for the purposes of selection of one software payment application from among a plurality of software payment applications within the same payment card.

“Priority tag value” shall mean a data value assigned to a priority tag.

“Proximity payment system environment” or “PPSE” shall mean a directory structure or data record structure maintained within a memory of a payment card—and which is configured to hold records containing one or more software payment applications that are stored within a payment card.

“Software payment application” shall mean any software application or software data file or data record that is stored within a memory in a payment card, and which stores one or more of (i) a payment account number corresponding to the payment card, (ii) an application identifier associated with the specific software payment application, (iii) a priority tag comprising priority information associated with the software payment application, (iv) one or more security keys associated with the payment card, or with a corresponding payment card account, or with the specific software payment application, or with a corresponding payment network, and/or a corresponding issuer institution, (v) a payment network identifier and/or (vi) an issuer institution identifier.

The present invention relates to the domain of payment card transactions, and more particularly to methods, systems and computer program products for managing and selectively modifying the configuration of a chip based payment card that has a plurality of software payment applications implemented therewithin. The invention enables secure modification of priority tags assigned to software payment applications within a payment card, so as to enable a user to modify the order of selection of payment functionality when a contactless payment card is used for a payment transaction.

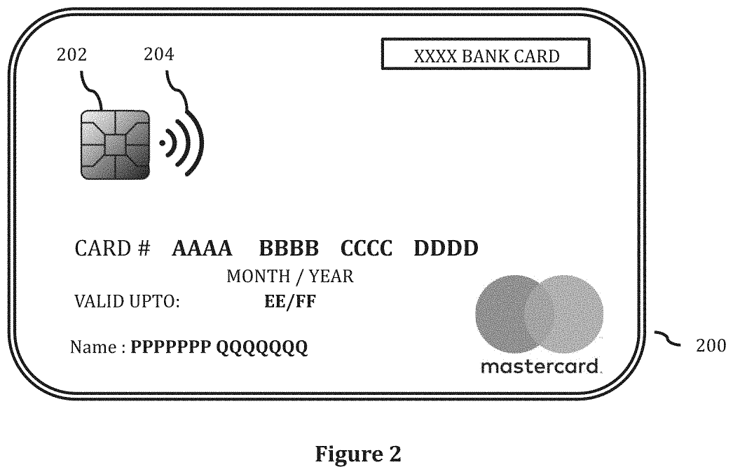

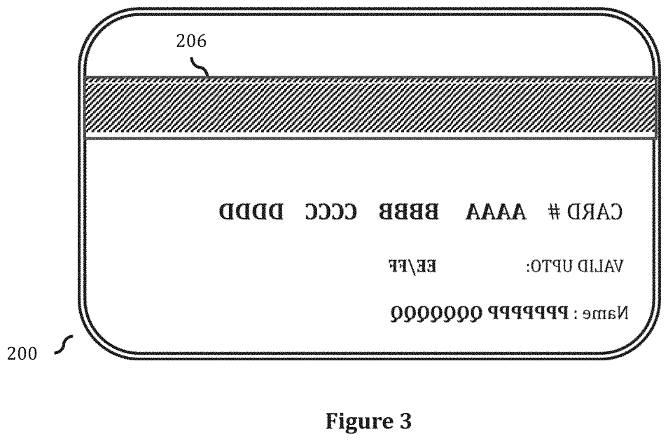

FIGS. 2 and 3 respectively illustrate front and rear views of a payment card 200 of a type discussed for the purposes of the present invention. Payment card 200 comprises a plastic substrate having card information printed thereon (for example, the card holder's name, validity period, issuer name, payment institution name and a card verification value or card verification code). Payment card 200 additionally includes (i) a microprocessor chip or smartchip 202 that is configured to encode and store all or part of the printed card information, along with additional information, and that is configured to interact with a point-of-sale (POS) terminal through a smartchip reader integrated into or coupled with a POS terminal, to enable the POS terminal to read payment card information stored within the smartchip, (ii) a contactless device or contactless chip 204 that is that is configured to interact with a point-of-sale (POS) terminal contactlessly and to transmit to a contactless signal receiver integrated into or coupled with a POS terminal, payment card information corresponding to the payment card, and (iii) a magnetic stripe 206 disposed on a surface of the substrate—which encodes and stores all or part of the printed card information, along with additional information, and which can be swiped through a magnetic card reader integrated into or coupled with a POS terminal, to enable the POS terminal to read payment card information stored on magnetic stripe 206.

In an embodiment of the present invention, payment card 200 requires at least one of a microprocessor chip or smartchip 202, or a contactless device or contactless chip 204 implemented therein.

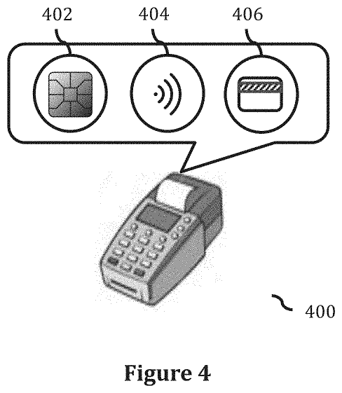

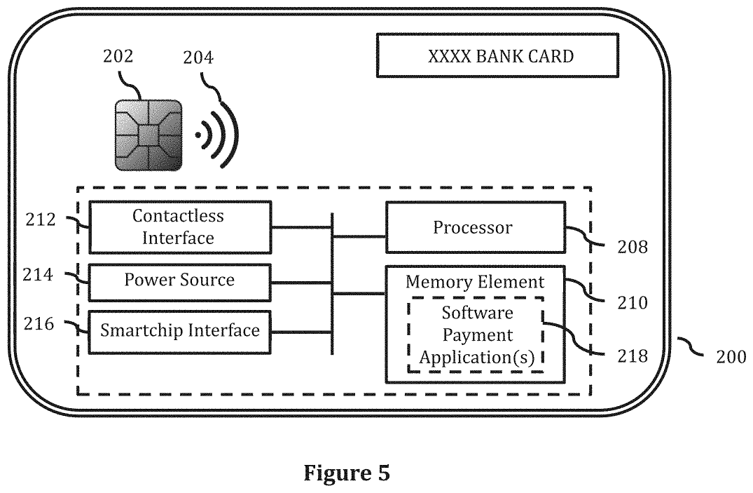

FIG. 5 illustrates an exemplary point-of-sale (POS) terminal 400 of a type discussed in the present invention, that is configured to interface with payment cards through any of a plurality of payment card interfaces. As shown in FIG. 4, POS terminal 400 may be configured to interact with payment cards through any of a payment card smartchip 202 (for example, through a smartchip reader integrated into or coupled with POS terminal 400), a payment card contactless chip 204 (for example, through a contactless transceiver integrated into or coupled with POS terminal 400), and a payment card magnetic stripe 206 (for example, through a magnetic stripe reader integrated into or coupled with POS terminal 400).

FIG. 5 illustrates internal components of payment card 200—comprising processor 208, memory element 210, contactless interface 212, an optional power source 214, and smartchip interface 216. Processor 208 comprises a processor component of smartchip 202. Memory 210 comprises a non-transitory or transitory memory configured to store information corresponding to the payment card. In an embodiment of the invention, memory element 210 has stored therewithin one or more software payment applications 218—wherein each software payment application comprises any of a software application, a software data file or a data record that is stored within memory 210 in payment card 200, and which stores one or more of (i) a payment account number corresponding to the payment card 200, (ii) an application identifier associated with the specific software payment application, (iii) a priority tag comprising priority information associated with the software payment application, (iv) one or more security keys associated with the payment card 200, or with a corresponding payment card account, or with the specific software payment application, or with a corresponding payment network, and/or a corresponding issuer institution, (v) a payment network identifier associated with payment card 200 and/or (vi) an issuer institution identifier associated with payment card 200.

Contactless interface 212 is an interface component associated with contactless chip 204 and may be configured for enabling near field communication protocol based data communication (or contactless data communication or contactless data communication based on any other wireless communication protocol or contactless communication protocol). In an embodiment, contactless interface 212 may comprise a contactless transmitter capable of communicating with one or more other devices having near field communication capabilities or contactless communication capabilities. Power source 214 may comprise an optional power source component for providing power to processor 208. Smartchip interface 216 comprises an interface component associated with smartchip 202 and may be configured for data transfer from payment card 200 to a chip reader or contactless signal reader integrated into or coupled with a POS terminal.

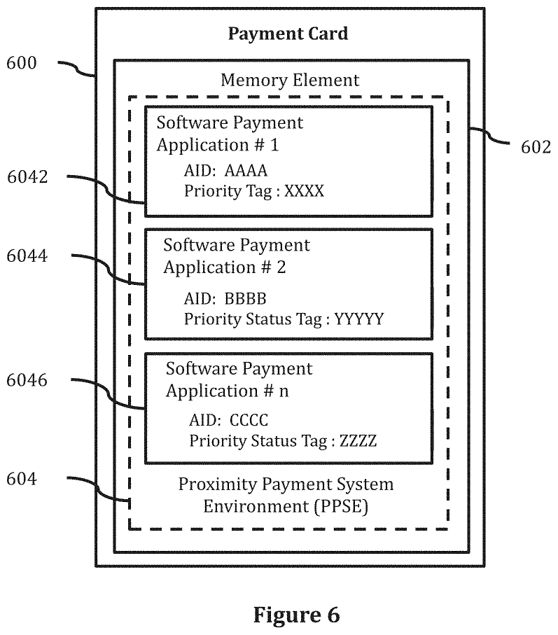

FIG. 6 illustrates a chip based payment card 600 of the type illustrated within FIG. 5, having a memory element 602 provided therewithin. Memory element 602 comprises at least a non-transitory memory storage or memory storage device, and may additionally include a transitory memory storage or memory storage device therewithin. Implemented within memory element 602 is a PPSE 604 comprising a directory structure or data record structure that stores records containing a plurality of software payment applications implemented within payment card 600. In the embodiment of FIG. 6, PPSE has stored therewithin a plurality of software payment applications including software payment application #1 (6042), software payment application #2 (6044) up to software payment application #n (6046).

Each of the plurality of software payment applications stored within memory element 602 includes at least an application identifier (AID) associated with the respective software payment application, and a priority tag associated with the respective software payment application. Each application identifier comprises a unique identifier associated with the corresponding software payment application. Each priority tag comprises a data field associated with the respective software payment application, and comprises one or more data values that represent a priority assigned to the software payment application for the purposes of enabling selection of one software payment application from among a plurality of software payment applications within the same payment card. Software payment application #1 (6062) has an application identifier value “AAAA” and a priority tag value “XXXX”. Software payment application #2 (6064) has an application identifier value “BBBB” and a priority tag value “YYYY”. Software payment application #3 (6066) has an application identifier value “CCCC” and a priority tag value “ZZZZ”.

As discussed earlier, the objective of assigning priority tags to each software payment application within the payment card is to ensure that when the payment card is used for a contactless payment transaction, the payment card processor is capable of correctly selecting a software payment application for retrieval and execution from among the plurality of software payment applications.

By way of example, this can be achieved by assigning a priority tag value of ‘active’ (or an equivalent) to one of the plurality of software payment applications, and a priority tag value of ‘inactive’ (or an equivalent) to the remaining software payment applications within said plurality of payment applications. In this example, the processor within the payment card may be configured so that, responsive to triggering of a contactless payment event involving the payment card and a contactless card reader, the processor identifies that software payment application having the priority tag value ‘active’ and implements the payment transaction using the identified software payment application.

In another example, the same objective can be achieved by assigning a numerical priority tag value to each of the plurality of software payment applications. In this example, the processor within the payment card may be configured so that, responsive to triggering of a contactless payment event involving the payment card and a contactless card reader, the processor selects a software payment application based on its priority tag value (e.g. selects the software payment application that has the highest or the lowest priority tag value) and implements the payment transaction using the selected software payment application.

Based on the above, it would be understood that changing a configuration of a payment card to change the default software payment application that is selected for a contactless payment event, would require modification of one or more priority tags associated with one or more of the plurality of software payment applications stored within the payment card. However to ensure that any such modifications are managed securely and only in response to instructions from an authorized entity (for example by any authorized cardholder or from an issuer), any such modifications require participation of an issuer (or an issuer network) associated with the payment card—so that any modifications are permitted only with the prior authorization of, or prior intimation to the issuer or the issuer network.

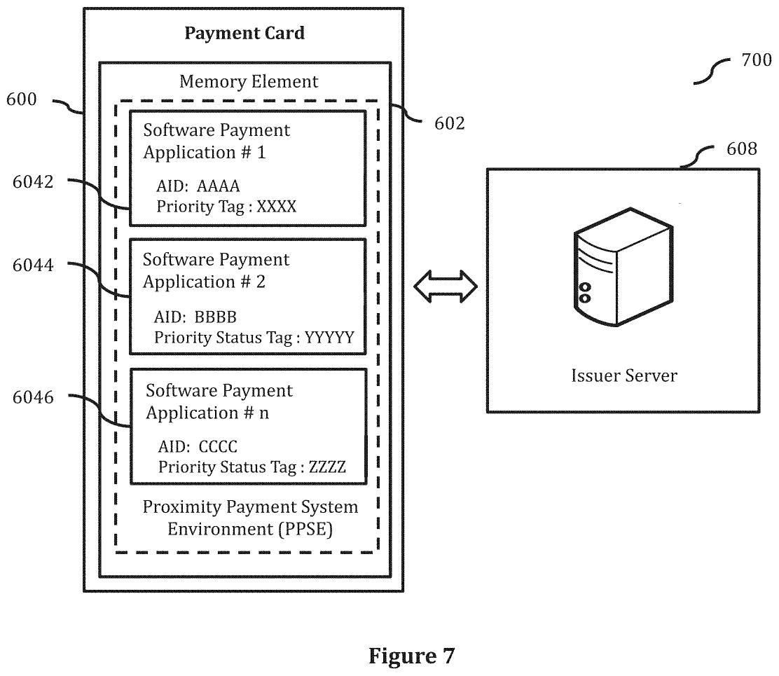

FIG. 7 illustrates a system environment 700 wherein the payment card 600 (as described previously in connection with FIG. 6) requires to be communicably coupled with an issuer server 608 for the purpose of ensuring that the issuer server 608 (and an issuer network within which the issuer server 608 is located) has been intimated of, and optionally has authorized, a proposed change in priority parameters corresponding to one or more software payment applications (6042 to 6046) within contactless payment card 600.

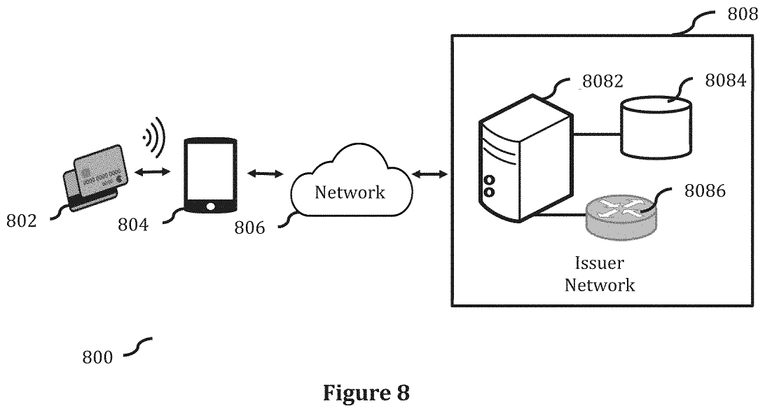

FIG. 8 illustrates a more detailed system environment 800 configured to enable secure modification of priority parameters corresponding to one or more software payment applications within a contactless payment card, based on intimation to, and authorization from an issuer network. In particular, the system environment 800 enables modification of priority parameters corresponding to one or more software payment applications within a contactless payment card without having to surrender, or submit the payment card to the card issuer, for carrying out the proposed modification(s).

System environment 800 comprises a contactless payment card 802 that is in wireless communication based (for example near-field communication (NFC) based or radio frequency identifier (RFID) based) communication with a mobile communication device 804. Mobile communication device 804 comprises any processor based mobile device configured for contactless communication (for example near-field communication (NFC) or radio frequency identifier (RFID) communication) with contactless payment card 802, and additionally configured for network based communication with an issuer network 808, through network 806. Network 806 may comprise any communication network or data network (for example, a TCP/IP network, the internet, or any other data network) that enables mobile communication device 804 to send data to and receive data from issuer network 808.

Issuer network 808 in turn comprises at least an issuer server 8082, an issuer database 8084 and issuer gateway interface 8086. For the purposes of this embodiment, the issuer server 8082 may include at least one processor, and one or more transitory and/or non-transitory memories. Issuer server 8082 may be configured (i) to maintain payment accounts held with the issuer, (ii) to enable electronic access to payment accounts held with the issuer, (iii) to enable electronic payment transactions involving payment accounts held with the issuer and/or (iv) to enable electronic payment transactions involving payment cards issued by the issuer. For the purposes of the embodiment, issuer database 8084 may include a non-transitory memory based database, configured to store data records corresponding to users and electronic payment accounts that are maintained at issuer network 808 and/or corresponding to payment cards associated with the issuer network 808. Issuer gateway interface 8086 may include a hardware or software network gateway configured to enable transmission and receipt of communications by issuer network 808 and/or issuer server 8082.

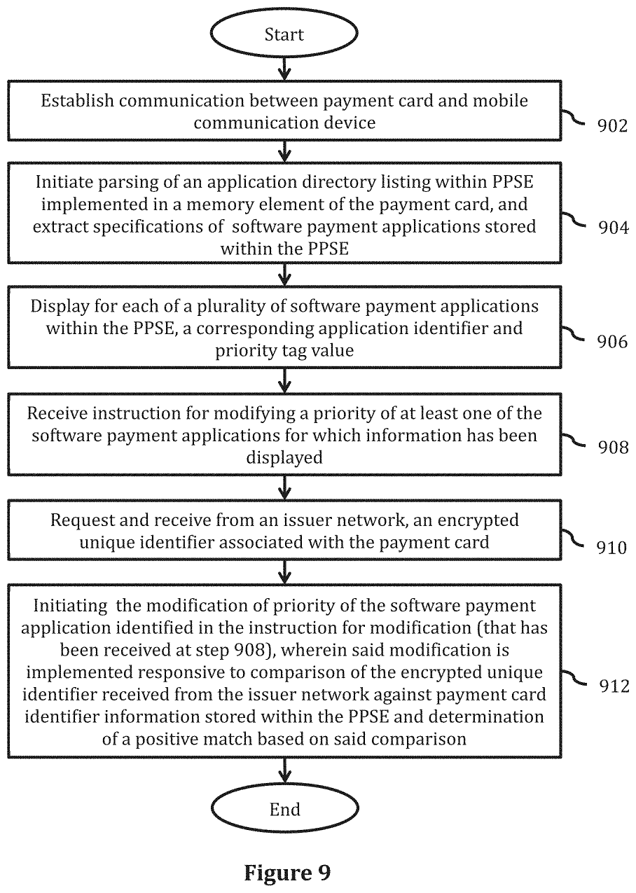

Mobile communication device 804 may have implemented therewithin, a mobile software application that enables communication between contactless payment card 802 and mobile communication device 804. The mobile software application is configured to receive software payment application information from contactless payment card 802 and to display this information to a user of the mobile communication device 804 through a mobile communication device display. The displayed information may include names and/or application identifiers identifying one or more software payment applications stored within a PPSE within contactless payment card 802, and/or priority information representing priority tag values assigned to each such software payment applications. The mobile software application may additionally be configured to receive through a mobile communication device user interface, user instructions for modifying one or more priority tag values assigned to software payment applications stored within the PPSE within contactless payment card 802. The mobile software application may also be configured to respond to such user instructions by implementing one or more process flows to modify priority tag values assigned to software payment applications stored within the PPSE within contactless payment card 802, in accordance with the teachings of the present invention. Yet further, the mobile software application may be configured to enable intimation to, and authorization from an issuer network, as part of the process flows for modifying priority tag values assigned to software payment applications stored within the PPSE within contactless payment card 802. Process flows of the kind that may be implemented by the mobile software application are discussed in more detail in connection with FIGS. 9 to 11 below.

FIG. 9 is a flowchart illustrating a method of configuring priority parameters corresponding to one or more software payment applications within a contactless payment card. In an embodiment of the invention, the method of FIG. 9 is implemented within mobile communication device 804 of FIG. 8.

Step 902 comprises establishing communication between a payment card and a mobile communication device. In an embodiment, the payment card may comprise a contactless payment card and the communication between the payment card and the mobile communication device may be implemented through wireless communication (for example using NFC or RFID communication capabilities of the payment card and the mobile communication device). In a specific embodiment, a communication session between the payment card and the mobile communication device may be initiated by a communication session trigger event—for e.g. by bringing the payment card and mobile communication device within communication range, or by tapping an NFC enabled payment card on an NFC enabled mobile communication device.

Step 904 comprises initiating parsing of an application directory listing (which comprises a listing of software payment applications stored within the PPSE and their respective attributes) within a PPSE (or implemented in a memory element of the payment card). Step 904 further comprises extracting specifications of (or information corresponding to) software payment applications stored within the PPSE. The step of parsing of the application directory listing within the PPSE may be initiated by an instruction communicated from the mobile communication device to the processor of the payment card.

In an embodiment, the application directory listing may be parsed by the payment card processor and the extracted specifications or information may be transmitted to the mobile communication device. In another embodiment, the application directory listing may be transmitted by the payment card processor to the mobile communication device—and the step of parsing the listing and extracting specifications or information may be implemented by the mobile communication device processor. The extracted specifications or information corresponding to software payment applications stored within the PPSE may include information representing any one or more software payment application attributes or parameters, and in an embodiment includes at least an application identifier and a priority tag value associated with each of a plurality of software payment applications stored within the PPSE.

Step 906 comprises displaying at the mobile communication device, an application identifier and a priority tag value associated respectively with each of a plurality of software payment applications stored within the PPSE. The application identifiers and priority tag values displayed at step 906 may comprise application identifiers and priority tag values that have been extracted at step 904, or alternatively may comprise display data that represents in a user decipherable format, the application identifiers and/or priority tag values that have been extracted at step 904.

Step 908 comprises receiving instructions for modifying a priority of at least one of the software payment applications. The instructions for modifying a priority (i.e. a priority tag value) of at least one of the software payment applications may be received at the mobile communication device, from a user or operator of the mobile communication device through a user interface. The received instructions may include a user selection that identifies the at least one software payment application for which a priority (or priority tag value) requires to be modified and additionally includes information representing the desired modification (that is intended to be implemented) of a priority or a priority tag value associated with said at least one software payment application.

Step 910 comprises implementing at the mobile communication device, the steps of requesting and receiving from an issuer network, or from an issuer server, an encrypted unique identifier associated with the payment card. The request for the encrypted unique identifier is transmitted from the mobile communication device to the issuer server/issuer network along with information identifying at least the payment card, and optionally information identifying the at least one software payment application for which a priority is sought to be modified. The encrypted unique identifier that is transmitted back from the issuer server/issuer network to the mobile communication device may comprise encrypted data that has been generated by encrypting a unique identifier that is associated with the payment card, or with a payment card account linked to the payment card, or with a software payment application within the payment card for which a priority modification instruction has been received at step 908. In a more specific embodiment, the unique identifier that is encrypted and transmitted by the issuer server/issuer network is identical to a unique identifier that is stored within the PPSE or within a secure memory element of the payment card.

In an embodiment of the invention, the issuer server/issuer network responds to the request for an encrypted unique identifier associated with the payment card only after authenticating an identity of (i) the mobile communication device, (ii) the user of the mobile communication device and/or (iii) a software application installed on the mobile communication device (through which the request for an encrypted unique identifier has been generated and transmitted), and/or after ascertaining that said mobile communication device/user/software application is authorized to modify priority tag values within the payment card in question. The issuer server/issuer network may implement this authentication/determination step based on any one or more authentication or identity verification process flows that would be apparent to the skilled person—and which may inter alia rely on comparing user identifiers/device identifiers/software application identifiers received from the mobile communication device, against corresponding user identifiers/device identifiers/software application identifiers associated with the payment card within the data records of the issuer server/issuer network.

The unique identifier is encrypted by the issuer network or issuer server prior to transmission to the mobile communication device. Encryption of the issuer network may be implemented through any cryptographic function or cryptographic transform—and may in various embodiments involve encryption using either symmetric key cryptography or asymmetric key cryptography.

In an embodiment, the encryption is carried out using one or more encryption keys selected such that the encrypted unique identifier is capable of being decrypted using a cryptographic key stored within a memory of the payment card. This cryptographic key may in an embodiment not be stored within or accessible by the mobile communication device. In an embodiment where the unique identifier is encrypted using a symmetric key cryptographic transformation, the symmetric key used for the cryptographic transform is also stored within a memory of the payment card. In an embodiment where the unique identifier is encrypted using a symmetric key cryptographic transformation, the key that is used for the cryptographic transform comprises one of a private key-public key pair, and the other of said private key-public key pair is stored within a memory of the payment card. While the encrypted unique identifier is transmitted from the issuer network/issuer server to the mobile communication device, in an embodiment of the method the key required for decrypting the unique identifier (i.e. in the case of symmetric key cryptographic transformation, the symmetric encryption key, and in the case of asymmetric key cryptographic transformation, the public key out of the public-private key pair) is not transmitted to the mobile communication device—and as a result, the mobile communication device is precluded from decrypting the received encrypted unique identifier.

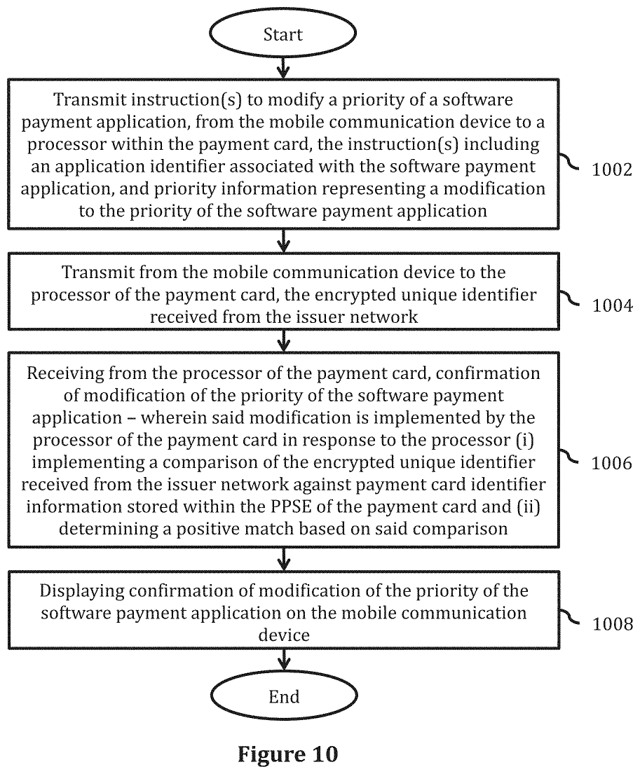

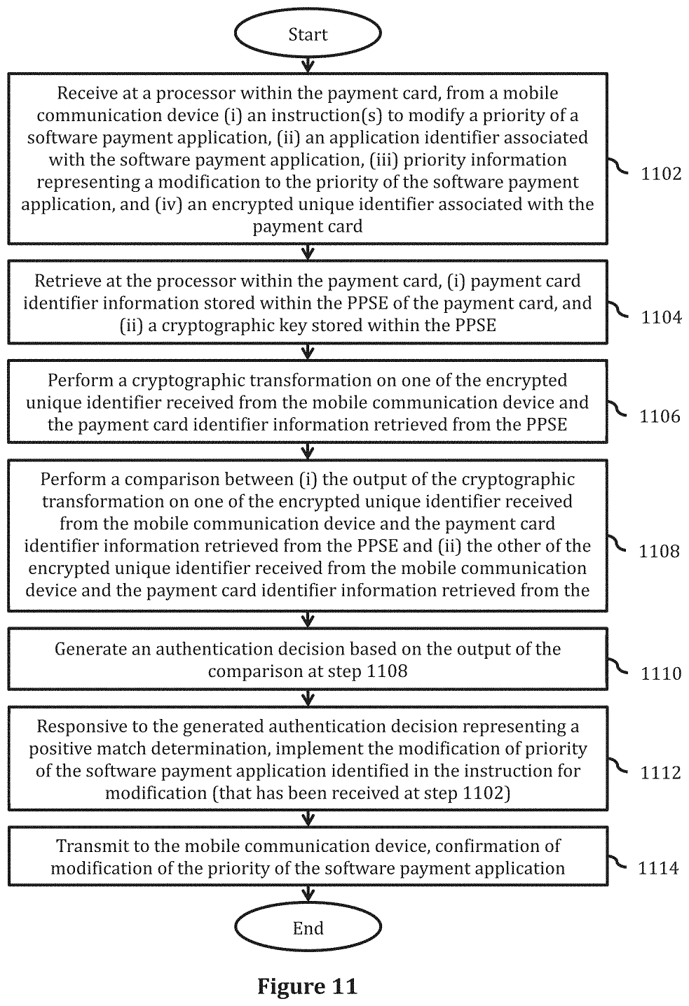

Step 912 comprises initiating at the mobile communication device, the step of implementing the modification of priority of the software payment application identified in the instruction for modification (that has been received at step 908). The modification is initiated by the mobile communication device by transmitting an instruction for modification to a processor of the payment card, along with the encrypted unique identifier received from the issuer server/issuer network at step 910. Said modification is subsequently implemented by the processor of the payment card responsive to (i) the processor comparing the encrypted unique identifier received from the issuer server/issuer network against payment card identifier information stored within the PPSE, and (ii) the processor determining a positive match based on said comparison step. Embodiments of step 910 are described in more detail in connection with FIGS. 10 and 11 below.

FIG. 10 is a flowchart illustrating method steps implemented within the mobile communication device for modifying priority parameters corresponding to one or more software payment applications within a contactless payment card. In a specific embodiment, the method steps of FIG. 10 may be implemented for the purposes of implementing method step 912 of FIG. 9 (as described above).

Step 1002 comprises transmitting from the mobile communication device to a processor within the payment card, instruction(s) to modify a priority or priority tag value of a software payment application. The transmitted instruction(s) includes or may be accompanied by an application identifier associated with the software payment application, and priority information representing an instructed modification to the priority or priority tag value of the software payment application. In an embodiment, the application identifier may comprise an AID value associated with the software payment application. The priority information may include a priority tag value that requires to be assigned to a priority tag associated with the software payment application.

Step 1004 comprises transmitting from the mobile communication device to the processor of the payment card, the encrypted unique identifier that has been requested and received by the mobile communication device from the issuer server/issuer network (at step 910 of the method of FIG. 9).

At step 1006, the mobile communication device receives from the processor of the payment card, confirmation that the priority (or priority tag value) of the software payment application has been successfully modified. Said modification is implemented by the processor of the payment card in response to the processor (i) implementing a comparison of the encrypted unique identifier received from the issuer server/issuer network against payment card identifier information stored within the PPSE of the payment card and (ii) determining a positive match based on said comparison. In an embodiment, the payment card identifier information stored within the PPSE of the payment card is a copy of the unique identifier that has been encrypted and transmitted to the mobile communication device by the issuer server/issuer network (and which is further transmitted in encrypted form to the processor of the payment card at step 1004).

It will be understood that by comparing or matching the encrypted unique identifier received from the issuer server/issuer network against the payment card identifier information stored within the PPSE of the payment card, the processor of the payment card can (in the case of a match) determine that the instruction for modification of the priority tag (or priority tag value) associated with the software payment application has been authorized by an issuer server/issuer network associated with the payment card or with the concerned software payment application—and that the processor of the payment card can therefore proceed with the requested modification of the priority tag.

In an embodiment of method step 1006, the comparison of the encrypted unique identifier received from the issuer server/issuer network against payment card identifier information stored within the PPSE of the payment card involves the processor of the payment card (i) retrieving a cryptographic key associated with the issuer server/issuer network of said payment card—which cryptographic key may be stored within a memory element or a secure memory element of the payment card, (ii) retrieving from a memory element or a secure memory element of the payment card, payment card identifier information associated with the payment card, (iii) either encrypting the payment card identifier information retrieved from the memory element/secure memory element of the payment card using the retrieved cryptographic key, or decrypting the encrypted unique identifier received from the issuer server/issuer network using the retrieved cryptographic key, and (iv) comparing either (a) the payment card identifier information that has been retrieved from the memory element/secure memory element of the payment card and that has been encrypted, against the encrypted unique identifier received from the issuer server/issuer network or (b) the payment card identifier information that has been retrieved from the memory element/secure memory element of the payment card against the encrypted unique identifier received from the issuer server/issuer network and that has been subsequently decrypted.

In an embodiment of method step 1006, the cryptographic key retrieved from a memory element or a secure memory element of the payment card, is the same symmetric key that has been used for generating the encrypted unique identifier by the issuer server/issuer network. In another embodiment of method step 1006, the cryptographic key retrieved from a memory element or a secure memory element of the payment card, is one of a private key-public key pair, and wherein the other of said private key-public key pair has been used for generating the encrypted unique identifier by the issuer server/issuer network. While the results of the comparison at step 1006 may be transmitted to the mobile communication device, in embodiments of the invention, one or both of the payment card identifier information stored in the memory element or secure memory element of the payment card, and the cryptographic key retrieved from the memory element or secure memory element of the payment card, are not transmitted by the processor of the payment card to the mobile communication device—thereby maintaining security of one or both of these data elements.

Step 1008 comprises displaying at the mobile communication device (for example, to a user or operator of the mobile communication device) confirmation of successful modification of the priority or priority tag value of the software payment application within the payment card—so that the operator or user of the mobile communication device is notified that the instructed modification of priority has been successfully implemented.

FIG. 11 is a flowchart illustrating payment card processor implemented method steps involved in configuring priority parameters corresponding to one or more software payment applications within a contactless payment card. In an embodiment, the method of FIG. 11 is implemented as part of the process flow that is initiated at step 912 of the method of FIG. 9.

Step 1102 comprises receiving at a processor within the payment card, from the mobile communication device, (i) an instruction(s) to modify a priority or priority tag value of a software payment application, (ii) an application identifier associated with the software payment application, (iii) priority information representing a modification to the priority or a priority tag value of the software payment application, and (iv) an encrypted unique identifier associated with the payment card.

Step 1104 comprises retrieving at the processor within the payment card, (i) payment card identifier information stored within the PPSE of the payment card (or within a memory element or secure memory element within the payment card), and (ii) a cryptographic key stored within the PPSE (or within a memory element or secure memory element within the payment card).

In an embodiment, the payment card identifier information retrieved from the PPSE of the payment card (or from a memory element or secure memory element within the payment card) is a copy of a unique identifier that is associated within the records of an issuer server/issuer network with the payment card, and which unique identifier has in an embodiment been encrypted and transmitted to the mobile communication device by the issuer server/issuer network (and which is further transmitted in encrypted form to the processor of the payment card at step 1004 of FIG. 10). It will be understood that by comparing or matching the encrypted unique identifier received from the issuer server/issuer network against the payment card identifier information stored within the payment card, the processor of the payment card can (in the case of a match) determine that the instruction for modification of the priority tag (or priority tag value) associated with the software payment application has been authorized by an issuer server/issuer network associated with the payment card or with the concerned software payment application—and that the processor of the payment card can therefore proceed with the requested modification of the priority tag.

In an embodiment of method step 1104, the cryptographic key retrieved from the PPSE, memory element or secure memory element of the payment card, is identical to a symmetric key that is used by an issuer server/issuer network (that is associated with the payment card) for encrypting unique identifiers associated with the payment card prior to transmission of such unique identifiers. In another embodiment the cryptographic key retrieved from the PPSE, or memory element or a secure memory element of the payment card, is one of a private key-public key pair, and wherein the other of said private key-public key pair is used by an issuer server/issuer network (that is associated with the payment card) for encrypting unique identifiers associated with the payment card prior to transmission of such unique identifiers.

Step 1106 comprises performing a cryptographic transformation on one of the encrypted unique identifier received from the mobile communication device (at step 1102) and the payment card identifier information retrieved from the PPSE/memory element (at step 1104)—wherein said cryptographic transformation is performed using the cryptographic key retrieved from the PPSE/memory element/secure memory element of the payment card (at step 1104). In one embodiment, the cryptographic transformation comprises encrypting the payment card identifier information retrieved from the PPSE/memory element/secure memory element of the payment card using the retrieved cryptographic key. In another embodiment, the cryptographic transformation comprises decrypting the encrypted unique identifier received from the mobile communication device using the retrieved cryptographic key.

Step 1108 comprises performing a comparison between (i) the output of the cryptographic transformation on one of the encrypted unique identifier received from the mobile communication device and the payment card identifier information retrieved from the PPSE/memory element/secure memory element of the payment card and (ii) the other of the encrypted unique identifier received from the mobile communication device and the payment card identifier information retrieved from the PPSE/memory element/secure memory element

Step 1110 comprises generating an authentication decision based on the output of the comparison at step 1108. It would be understood that the comparison at step 1108 may result either in a match or a non-match. In an embodiment, the authentication decision comprises a positive authentication decision, provided the comparison at step 1108 has resulted in a match. In an embodiment, the authentication decision comprises a negative authentication decision, provided the comparison at step 1108 has resulted in a non-match.

At step 1112, responsive to the generated authentication decision representing a positive authentication decision, the processor within the payment card implements the modification of a priority (or priority tag value) of the software payment application that has been identified in the instruction for modification (that has been received at step 1102). It would be understood that responsive to the generated authentication decision representing a negative authentication decision, the processor within the payment card does not implement (or rejects or discards a received instruction for) the modification of priority (or priority tag value) of the software payment application that has been identified in the instruction for modification (that has been received at step 1102).

Step 1114 comprises transmitting from the processor within the payment card, to the mobile communication device, confirmation of modification of the priority (or priority tag value) of the software payment application

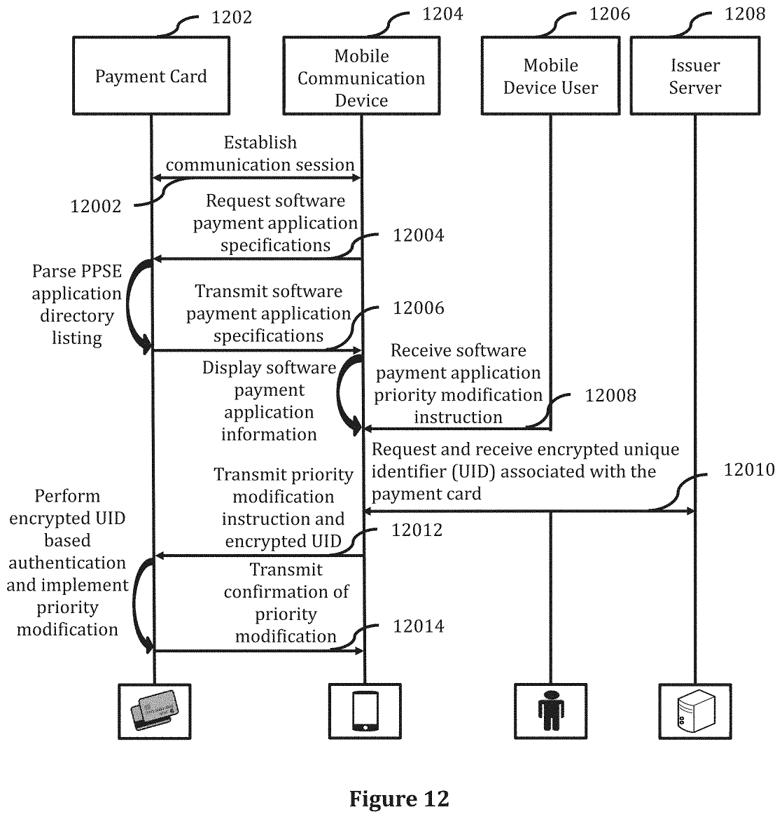

FIG. 12 is a communication flow diagram illustrating communication flow between system entities involved in configuring priority parameters corresponding to one or more software payment applications within a contactless payment card. In an embodiment, the communication flow of FIG. 12 is implemented during the process flows of the method of FIG. 9.

Step 12002 comprises establishing a communication session between a payment card 1202 and a mobile communication device 1204. The payment card 1202 may comprise a contactless payment card, and the communication session between the payment card 1202 and the mobile communication device 1204 may be implemented through wireless communication (for example using NFC or RFID communication capabilities of the payment card 1202 and the mobile communication device 1204). In a specific embodiment, a communication session between the payment card 1202 and the mobile communication device 1204 may be initiated by a communication session trigger event—for e.g. by bringing the payment card 1202 and mobile communication device 1204 within communication range, or by tapping an NFC enabled payment card 1202 on an NFC enabled mobile communication device 1204.

Step 12004 comprises mobile communication device 1204 transmitting to payment card 1202, a request for software payment application specifications. In an embodiment, the transmitted request comprises a request for specifications or information corresponding to software payment applications stored within a PPSE (or within a memory element) within the payment card 1202.

Responsive to the received request, payment card 1202 parses an application directory listing within a PPSE or within a memory element of the payment card 1202, and extracts specifications or information corresponding to software payment applications stored within the PPSE or within the memory element of the payment card 1202. Based on the results of the parsing step, at step 12006 payment card 1202 transmits back to mobile communication device 1204, the requested specifications or information corresponding to software payment applications stored within the PPSE or a memory element of the payment card 1202.

Mobile communication device 1204 displays the received specifications or information (corresponding to software payment applications stored within the PPSE or within the memory element of the payment card 1202) to a mobile device user 1206 who is operating mobile communication device 1204.

At step 12008, mobile communication device 1204 receives by way of input from mobile device user 1206, a software payment application priority modification instruction. The received instruction may include a user selection that identifies the at least one software payment application for which a priority (or priority tag value) requires to be modified and additionally includes information representing the modification (that is intended to be implemented) of a priority or a priority tag value associated with said at least one software payment application.

At step 12010, mobile communication device 1204 requests and receives from an issuer server 1208 (that is operated or controlled by an issuer associated with payment card 1202) an encrypted unique identifier (UID) associated with payment card 1202. The encrypted unique identifier that is transmitted back from the issuer server 1208 to the mobile communication device 1204 may comprise encrypted data that has been generated by encrypting a unique identifier that is associated with the payment card 1202, or with a payment card account linked to the payment card 1202, or with a software payment application within the payment card 1202 for which a priority modification instruction has been received at step 12008. In a more specific embodiment, the unique identifier that is encrypted and transmitted by the issuer server/issuer network is a unique identifier that is additionally stored within the PPSE or within a secure memory element of the payment card.

At step 12012 mobile communication device 1204 transmits to payment card 1202, an instruction for modification of a priority or priority tag value corresponding to a software payment application stored within a PPSE or memory element within payment card 1202. Said transmission includes or is accompanied by transmission of the encrypted unique identifier, from mobile communication device 1204 to payment card 1202.

Payment card 1202 responds to the instruction transmitted at step 12012 by comparing (i) the encrypted unique identifier received from the issuer server/issuer network against payment card identifier information stored within the PPSE, and (ii) responsive to a match decision/positive authentication decision arising out of said comparison, implementing the instructed modification of priority (or priority tag value) associated with a software payment application within payment card 1202.

As discussed above, the comparison of the encrypted unique identifier received from the issuer server 1208 against payment card identifier information stored within the PPSE of the payment card 1202 involves the processor of the payment card 1202 (i) retrieving a cryptographic key associated with the issuer server 1208 of said payment card 1202—which cryptographic key may be stored within a memory element or a secure memory element of the payment card 1202, (ii) retrieving from a memory element or a secure memory element of the payment card 1202, payment card identifier information associated with the payment card 1202, (iii) either encrypting the payment card identifier information retrieved from the memory element/secure memory element of the payment card 1202 using the retrieved cryptographic key, or decrypting the encrypted unique identifier received from the issuer server 1208 using the retrieved cryptographic key, and (iv) comparing either (a) the payment card identifier information that has been retrieved from the memory element/secure memory element of the payment card 1202 and that has been encrypted, against the encrypted unique identifier received from the issuer server 1208 or (b) the payment card identifier information that has been retrieved from the memory element/secure memory element of the payment card 1202 against the encrypted unique identifier received from the issuer server 1208 and that has been subsequently decrypted.

Additionally, as discussed above, the cryptographic key retrieved from a memory element or a secure memory element of the payment card 1202, is the same symmetric key that has been used for generating the encrypted unique identifier by the issuer server 1208. In another embodiment of method step 1006, the cryptographic key retrieved from a memory element or a secure memory element of the payment card 1202, is one of a private key-public key pair, and wherein the other of said private key-public key pair has been used for generating the encrypted unique identifier by the issuer server 1208.

Step 12014 comprises transmission of a confirmation message from payment card 1202 to mobile communication device 1204, said confirmation message confirming successful implementation of the instructed modification of priority (or priority tag value) associated with a software payment application within payment card 1202.

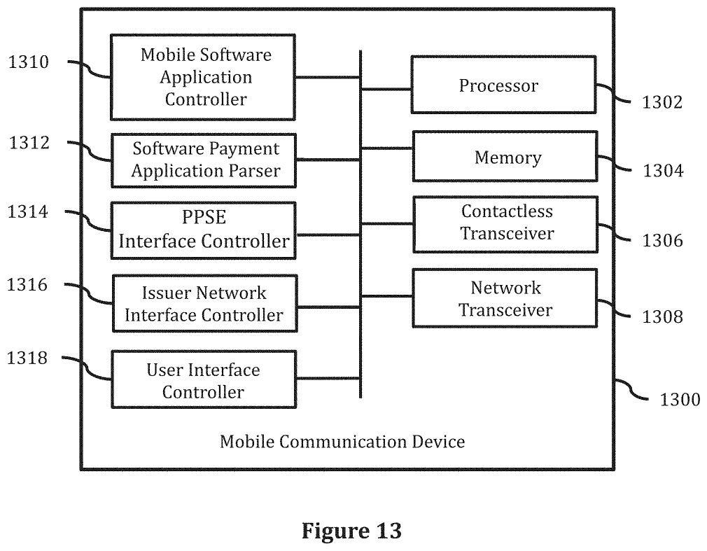

FIG. 13 illustrates internal components within an exemplary mobile communication device 1300 which has been configured to implement the method steps of FIGS. 9 and/or 10.

As shown in FIG. 13, mobile communication device 1300 includes (i) a processor 1302, (ii) a memory 1304, (iii) a contactless transceiver 1306 configured to send and receive data communications based on one or more contactless or contactless communication protocols (for example, a near field communication protocol or an RFID communication protocol), (iv) a network transceiver 1308 configured to send and receive data communications over a data network (for example a TCP/IP network, the internet, or any other data network) to enable mobile communication device 1300 to communicate with any of a data network, a payment network, an acquirer network and/or an issuer network.

Mobile communication device 1300 additionally includes a mobile software application controller 1310 configured to implement and control a mobile software application of a kind that has been described above in connection with FIG. 8. The mobile software application controller 1310 may be configured to implement within mobile communication device 1300, a mobile software application that is configured for one or more of (i) receiving software payment application information from a contactless payment card, (ii) displaying this information to a user of the mobile communication device 1300 through a mobile communication device display, (iii) receiving through a mobile communication device user interface, user instructions for modifying one or more priority tag values assigned to software payment applications stored within a PPSE within the contactless payment card, (iv) responding to such user instructions by implementing one or more process flows to modify priority tag values assigned to software payment applications stored within the PPSE within the contactless payment card, and (v) enabling intimation to, and authorization from, an issuer network as part of the process flows for modifying priority tag values assigned to software payment applications stored within the PPSE within the contactless payment card.

Mobile communication device 1300 may additionally include a software payment application parser 1312 that is configured to initiate parsing of an application directory listing within a PPSE of a contactless payment card for extracting specifications of (or information corresponding to) software payment applications stored within the PPSE.

Mobile communication device 1300 may also include a PPSE interface controller 1314 that is configured enable mobile communication device 1300 to initiate or participate in a communication session with a contactless payment card, and to transmit information to or receive information from the contactless payment card.

Additionally, mobile communication device 1300 may include an issuer network interface controller 1316 that is configured to enable mobile communication device 1300 to initiate or participate in a communication session with an issuer network or an issuer server, and to transmit information to or receive information from the issuer network or issuer server.

Mobile communication device 1300 may also include a user interface controller that enables presentation of information from a mobile software application implemented within mobile communication device 1300 to a user of mobile communication device 1300 through one or more user interfaces, and which enables the user to provide inputs to the mobile software application, through said one or more user interfaces.

In various embodiments, the one or more components of mobile communication device 1300 may be configured to implement one or more methods steps of FIG. 9 or 10 described above.

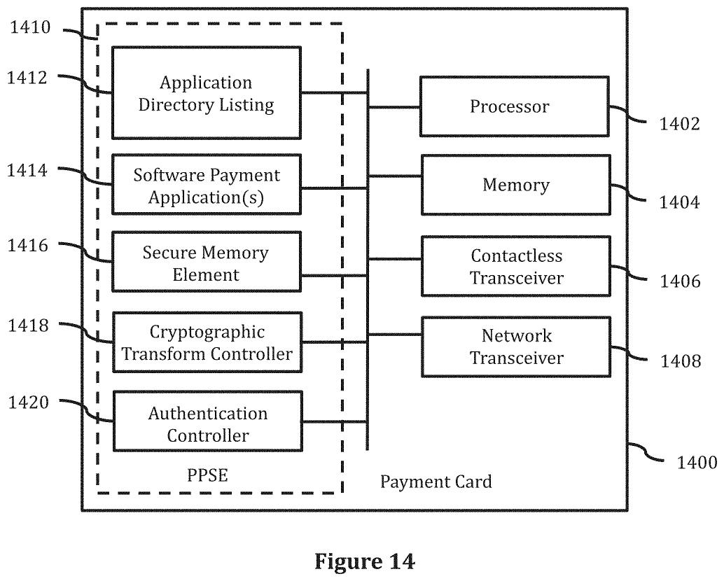

FIG. 14 illustrates internal components within an exemplary processor implemented payment card which may be configured to implement one or more method steps of FIGS. 9 and/or 11.

As shown in FIG. 14, payment card 1400 includes (i) a processor 1402, (ii) a memory 1404, (iii) a contactless transceiver 1406 configured to send and receive data communications based on one or more contactless or contactless communication protocols (for example, a near field communication protocol or an RFID communication protocol), and (iv) a transceiver antenna 1408 (for example, a coil antenna or a loop antenna) configured to enable contactless transceiver 1406 to send and receive data communications to another contactless transceiver implemented within another device.

Payment card 1400 additionally includes a PPSE 1410—which PPSE comprises a directory structure or data record structure maintained within a memory of payment card 1400—wherein the directory structure is configured to hold records containing one or more software payment applications that are stored within the payment card 1400. PPSE 1410 includes (i) an application directory listing 1412 comprising a listing of software payment applications 1414 stored within the PPSE and their respective attributes, (ii) one of more software payment application(s) 1414, (iii) a secure memory element 1416 comprising a dedicated memory element or a dedicated portion or partition within a larger memory element which has higher levels of access protection (in comparison with other memory within the PPSE) and which can only be accessed by specific access-secure applications or entities, and further which may in certain embodiments be used to store unique identifier(s) associated with payment card 1400 and/or cryptographic key(s) associated with payment card 1400 (iv) a cryptographic transform controller 1418 configured to perform one or more encryption/decryption functions on data (including on unique identifiers stored within PPSE 1410 or received from an issuer network/issuer server) based on one or more cryptographic keys stored within payment card 1400, and (v) authentication controller 1420 which may be configured to (a) compare a unique identifier received (in encrypted form) from an issuer server/issuer network against a unique identifier associated with payment card 1400 and which is retrieved from PPSE 1410 and (b) to generate an authentication decision (e.g. a match decision or a non-match decision) based on a result of the comparison.

In an embodiment, payment card 1400 and one or more components therein may be configured to implement one or more method steps described above in connection with FIGS. 9 and/or 11.

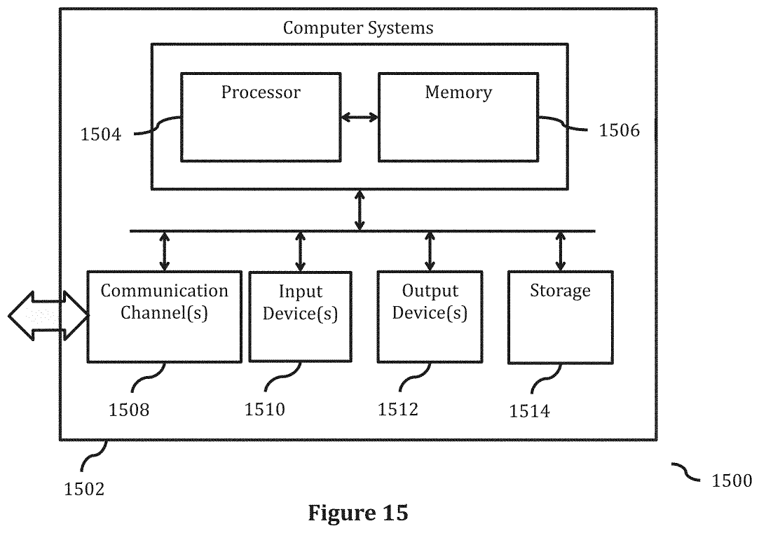

FIG. 15 illustrates an exemplary computer system 1500 according to which various embodiments of the present invention may be implemented.

System 1500 includes computer system 1502 which in turn comprises one or more processors 1504 and at least one memory 1506. Processor 1504 is configured to execute program instructions—and may be a real processor or a virtual processor. It will be understood that computer system 1502 does not suggest any limitation as to scope of use or functionality of described embodiments. The computer system 1502 may include, but is not limited to, one or more of a general-purpose computer, a programmed microprocessor, a micro-controller, an integrated circuit, and other devices or arrangements of devices that are capable of implementing the steps that constitute the method of the present invention.

Exemplary embodiments of a computer system 1502 in accordance with the present invention may include one or more servers, desktops, laptops, tablets, smart phones, mobile phones, mobile communication devices, phablets and personal digital assistants. In an embodiment of the present invention, the memory 1506 may store software for implementing various embodiments of the present invention. The computer system 1502 may have additional components. For example, the computer system 1502 may include one or more communication channels 1508, one or more input devices 1510, one or more output devices 1512, and storage 1514. An interconnection mechanism (not shown) such as a bus, controller, or network, interconnects the components of the computer system 1502. In various embodiments of the present invention, operating system software (not shown) provides an operating environment for various softwares executing in the computer system 1502 using a processor 1504, and manages different functionalities of the components of the computer system 1502.

The communication channel(s) 1508 allow communication over a communication medium to various other computing entities. The communication medium provides information such as program instructions, or other data in a communication media. The communication media includes, but is not limited to, wired or wireless or contactless methodologies implemented with an electrical, optical, RF, infrared, acoustic, microwave, Bluetooth or other transmission media.

The input device(s) 1510 may include, but is not limited to, a touch screen, a keyboard, mouse, pen, joystick, trackball, a voice device, a scanning device, or any another device that is capable of providing input to the computer system 1502. In an embodiment of the present invention, the input device(s) 1510 may be a sound card or similar device that accepts audio input in analog or digital form. The output device(s) 1512 may include, but not be limited to, a user interface on CRT, LCD, LED display, or any other display associated with any of servers, desktops, laptops, tablets, smart phones, mobile phones, mobile communication devices, phablets and personal digital assistants, printer, speaker, CD/DVD writer, or any other device that provides output from the computer system 1502.

The storage 1514 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1502. In various embodiments of the present invention, the storage 1514 may contain program instructions for implementing any of the described embodiments.

In an embodiment of the present invention, the computer system 1502 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1502. The method described herein is typically implemented as a computer program product, comprising a set of program instructions that is executed by the computer system 1502 or any other similar device. The set of program instructions may be a series of computer readable codes stored on a tangible medium, such as a computer readable storage medium (storage 1514), for example, diskette, CD-ROM, ROM, flash drives or hard disk, or transmittable to the computer system 1502, via a modem or other interface device, over either a tangible medium, including but not limited to optical or analogue communications channel(s) 1508. The implementation of the invention as a computer program product may be in an intangible form using wireless or contactless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be understood that the present invention enables a user or cardholder to conveniently modify the priority of one or more software payment applications within a contactless payment card—to enable modification of the order of selection of payment functionality when said contactless payment card is used for a contactless payment transaction. The invention additionally enables such modifications by the user or cardholder without having to surrender or submit the payment card to a card issuer for carrying out the modification, while simultaneously ensuring that the modifications are implemented in a secure manner that does not compromise security of any of the payment card, the card issuer or a payment network associated with the payment card.

While exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

We claim:

1. A method for modifying priority parameters corresponding to a software payment application within a contactless payment card, the method comprising:
establishing communication between the contactless payment card and a mobile communication device;
initiating parsing of an application directory listing stored within a memory of the contactless payment card;
extracting information corresponding to a plurality of software payment applications stored within the memory of the contactless payment card;
receiving user input selecting a software payment application from among the plurality of software payment applications;
receiving user input specifying a modification to a value of a priority tag associated with the selected software payment application;
receiving from an issuer server, an encrypted unique identifier associated with the contactless payment card; and
initiating modification of the priority tag associated with the selected software payment application, wherein:
said modification comprises implementing the modification to the value of the priority tag, as specified by the received user input; and
said modification is implemented responsive to a processor within the contactless payment card determining that the encrypted unique identifier received from the issuer server matches payment card identifier information stored within the memory of the contactless payment card.

2. The method as claimed in claim 1, wherein parsing of the application directory listing is implemented by the processor within the contactless payment card.

3. The method as claimed in claim 1, wherein the extracted information corresponding to each of the plurality of software applications comprises an application identifier and a priority tag value.

4. The method as claimed in claim 1, wherein the extracted information corresponding to each of the plurality of software applications is displayed on a display of the mobile communication device.

5. The method as claimed in claim 3, wherein the user input selecting a software payment application from among the plurality of software payment applications, comprises a selection of an application identifiers corresponding to one of the plurality of software applications.

6. The method as claimed in claim 1, wherein one or more of the application directory listing, the extracted information corresponding to the plurality of software payment applications, the plurality of software payment applications and the payment card identifier information are stored within a proximity payment system environment implemented within a memory of the contactless payment card.

7. The method as claimed in claim 1, wherein:
the modification to the value of the priority tag, as specified by the received user input is implemented by the processor within the contactless payment card; or
the determination that the encrypted unique identifier received from the issuer server matches payment card identifier information stored within the memory of the contactless payment card, is implemented by the processor within the contactless payment card.

8. The method as claimed in claim 1, wherein the determination that the encrypted unique identifier received from the issuer server matches payment card identifier information stored within the memory of the contactless payment card, is based on:
encrypting the payment card identifier information stored within the memory of the contactless payment card and comparing said encrypted payment card identifier information against the encrypted unique identifier received from the issuer server; or
decrypting the encrypted unique identifier received from the issuer server, and comparing the decrypted unique identifier against the payment card identifier information stored within the memory of the contactless payment card.

9. The method as claimed in claim 8, wherein:
encryption of the payment card identifier information stored within the memory of the contactless payment card, or decryption of the encrypted unique identifier received from the issuer server is based on a cryptographic key retrieved from the memory of the contactless payment card.

10. The method as claimed in claim 9, wherein:
the cryptographic key retrieved from the memory of the contactless payment card comprises a symmetric cryptographic key has been used by the issuer server to generate the encrypted unique identifier; or
the cryptographic key retrieved from the memory of the contactless payment card comprises one of a private key-public key pair, and the other of said private key-public key pair has been used by the issuer server to generate the encrypted unique identifier.

11. A mobile communication device configured for enabling modification of priority parameters corresponding to a software payment application within a contactless payment card, the mobile communication device comprising:
a memory;
a network transceiver;
a contactless transceiver configured to enable communication with contactless payment cards based on one or more wireless communication protocols; and
at least one processor configured for:
establishing communication between the contactless payment card and a mobile communication device;
initiating parsing of an application directory listing stored within a memory of the contactless payment card;
extracting information corresponding to a plurality of software payment applications stored within the memory of the contactless payment card;
receiving user input selecting a software payment application from among the plurality of software payment applications;
receiving user input specifying a modification to a value of a priority tag associated with the selected software payment application;
receiving from an issuer server, an encrypted unique identifier associated with the contactless payment card; and
initiating modification of the priority tag associated with the selected software payment application, wherein:
said modification comprises implementing the modification to the value of the priority tag, as specified by the received user input; and
said modification is implemented responsive to a processor within the contactless payment card determining that the encrypted unique identifier received from the issuer server matches payment card identifier information stored within the memory of the contactless payment card.

12. The mobile communication device as claimed in claim 11, configured such that parsing of the application directory listing is implemented by the processor within the contactless payment card.

13. The mobile communication device as claimed in claim 11, configured such that the extracted information corresponding to each of the plurality of software applications comprises an application identifier and a priority tag value.

14. The mobile communication device as claimed in claim 11, configured such that the extracted information corresponding to each of the plurality of software applications is displayed on a display of the mobile communication device.

15. The mobile communication device as claimed in claim 13, configured such that the user input selecting a software payment application from among the plurality of software payment applications, comprises a selection of an application identifiers corresponding to one of the plurality of software applications.

16. The mobile communication device as claimed in claim 11, configured such that one or more of the application directory listing, the extracted information corresponding to the plurality of software payment applications, the plurality of software payment applications and the payment card identifier information are stored within a proximity payment system environment implemented within a memory of the contactless payment card.

17. The mobile communication device as claimed in claim 11, configured such that:
the modification to the value of the priority tag, as specified by the received user input is implemented by the processor within the contactless payment card; or
the determination that the encrypted unique identifier received from the issuer server matches payment card identifier information stored within the memory of the contactless payment card, is implemented by the processor within the contactless payment card.

18. The mobile communication device as claimed in claim 11, configured such that the determination that the encrypted unique identifier received from the issuer server matches payment card identifier information stored within the memory of the contactless payment card, is based on:
encrypting the payment card identifier information stored within the memory of the contactless payment card and comparing said encrypted payment card identifier information against the encrypted unique identifier received from the issuer server; or
decrypting the encrypted unique identifier received from the issuer server, and comparing the decrypted unique identifier against the payment card identifier information stored within the memory of the contactless payment card.

19. The mobile communication device as claimed in claim 18, configured such that:
encryption of the payment card identifier information stored within the memory of the contactless payment card, or decryption of the encrypted unique identifier received from the issuer server is based on a cryptographic key retrieved from the memory of the contactless payment card.

20. A computer program product for modifying priority parameters corresponding to a software payment application within a contactless payment card, comprising a non-transitory computer usable medium having a computer readable program code embodied therein, the computer readable program code comprising instructions for:
establishing communication between the contactless payment card and a mobile communication device;
initiating parsing of an application directory listing stored within a memory of the contactless payment card;
extracting information corresponding to a plurality of software payment applications stored within the memory of the contactless payment card;
receiving user input selecting a software payment application from among the plurality of software payment applications;
receiving user input specifying a modification to a value of a priority tag associated with the selected software payment application;
receiving from an issuer server, an encrypted unique identifier associated with the contactless payment card; and
initiating modification of the priority tag associated with the selected software payment application, wherein:
said modification comprises implementing the modification to the value of the priority tag, as specified by the received user input; and
said modification is implemented responsive to a processor within the contactless payment card determining that the encrypted unique identifier received from the issuer server matches payment card identifier information stored within the memory of the contactless payment card.
